(19) United States
(12) Patent Application Publication
(10) Pub. No.: US 2011/0204607 A1
(43) Pub. Date: Aug. 25, 2011

(54) PREFORMED FLEXIBLE HOUSING FOR AIRBAG MODULE

(76) Inventors: Conrad Dumbrique, Lake Orion, MI (US); Michael Coulter, Waterford, MI (US)

(21) Appl. No.: 12/709,969

(22) Filed: Feb. 22, 2010

(51) Int. Cl. B60R 21/16

(52) U.S. Cl. 280/743.1

(57) ABSTRACT

A preformed flexibly resilient housing for retaining an airbag cushion and securing the airbag module to a vehicle structure. The preformed flexibly resilient housing has a persistent preformed shape and is flexible when subjected to stress. Features are added to the rim of the preformed flexibly resilient housing for interfacing with either a collar or the vehicle structure. The preformed flexibly resilient housing may be secured directly to the vehicle structure, or it may be secured using an intermediary such as a rigid collar. The preformed flexibly resilient housing may additionally have features for securing the preformed flexibly resilient housing to an inflation source.

### BACKGROUND OF THE INVENTION

The inclusion of inflatable safety restraint devices, or airbags, is now a legal requirement for many new vehicles. Airbags are typically installed in the steering wheel and in the dashboard on the passenger's side of a car. Additionally, airbags may be installed to inflate beside vehicle occupants to provide side impact protection, in front of the knees to protect the knees from impact, or at other strategic locations.

In the event of an accident, a sensor system within the vehicle senses an impact situation and triggers the ignition of an inflator. Inflation gases from the inflator fill the airbag cushions, which immediately inflate to protect the driver and/or passengers from impact against the interior surfaces of the vehicle. During normal vehicle operation, airbags are typically stowed behind covers to protect them from tampering and provide a more attractive interior facade for the vehicle.

Frontal impact airbags are often installed in the instrument panel of the vehicle. Such airbags may be installed on an upper surface of the instrument panel, or within the vehicle steering wheel. The inflator is installed proximate the airbag and is disposed such that inflation gas flows upward to cause the airbag cushion to expand upward. The folded cushion and the inflator are typically packaged within a housing that keeps the cushion folded and retains the inflator and cushion during deployment. In the past, such housings were typically formed of sheet metal or other rigid material.

Unfortunately, these previous rigid housings added significantly to the cost of the airbag module. In response, the flexible housing was developed wherein the housing is typically made of the same material as the air bag itself. Additionally, the housing was formed as a part of the cushion, forming an outer wall of the cushion. The complete module is then attached to the instrument panel by way of brackets. The flexible housing is typically made of airbag fabric that must be cut and sewn to its final shape.

### BRIEF SUMMARY OF THE INVENTION

Embodiments of a preformed flexibly resilient housing for an airbag module are disclosed herein. The flexibly resilient housing is utilized to retain an inflatable cushion in a compacted configuration prior to inflation and connects to the vehicle structure. The preformed flexibly resilient housing has at least one layer of a thermoplastic material and includes a chamber for receiving the inflatable cushion in its compacted configuration. Additionally, the preformed flexibly resilient housing has features adapted to secure the preformed flexibly resilient housing to the vehicle structure.

The preformed flexibly resilient housing can be secured to a vehicle structure directly, or may connect using a rigid collar. The rigid collar may secure to the preformed flexibly resilient housing and the vehicle structure, thereby securely attaching the preformed flexibly resilient housing to the vehicle structure. When the compacted cushion is inflated by an inflation source, the cushion is expelled from the preformed flexibly resilient housing and may pass through the rigid collar before deploying in the passenger chamber.

Other objects and advantages will be apparent to those skilled in the art from the following detailed description taken in conjunction with the appended claims and drawings.

### BRIEF DESCRIPTION OF THE SEVERAL VIEWS OF THE DRAWINGS

In order that the manner in which the above-recited and other features and advantage of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a side elevation view of an airbag module according to one embodiment of the invention, mounted as a passenger side, frontal impact airbag within the instrument panel of a sectioned vehicle, with the cushion in the compacted configuration.

FIG. 2a is view of a preformed flexibly resilient housing showing the general configuration of the preformed flexibly resilient housing.

FIG. 2b is a view of the preformed flexibly resilient housing showing a cavity and features that have been added for the retention of the preformed flexibly resilient housing.

FIG. 2c is a view of the preformed flexibly resilient housing showing further features for the retention of an airbag inflation source.

FIG. 3 is a view of an assembled airbag module in accordance with one embodiment of the invention, showing the preformed flexibly resilient housing secured to a rigid collar and inflation source, further containing a cutout showing the cushion in the compacted configuration.

FIG. 4. is a flow chart showing acts to perform a method for assembling the airbag module.

### DETAILED DESCRIPTION OF THE INVENTION

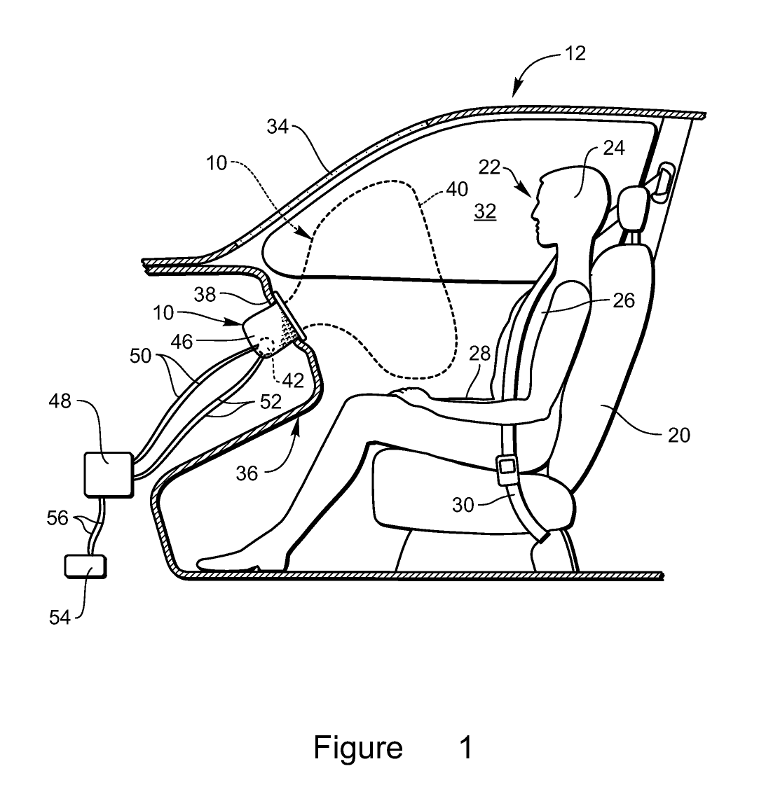

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 5, is not intended to limit the scope of the invention, as claimed, but is merely representative of presently preferred embodiments of the invention.

For this application, the phrases “connected to,” “coupled to,” and “in communication with” refer to any form of interaction between two or more entities, including mechanical, electrical, magnetic, electromagnetic, and thermal interaction. The phrase “attached to” refers to a form of mechanical coupling that restricts relative translation or rotation between the attached objects. The phrases “pivotally attached to” and “slidably attached to” refer to forms of mechanical coupling that permit relative rotation or relative translation, respectively, while restricting other relative motion.

The phrase “attached directly to” refers to a form of attachment by which the attached items are either in direct contact, or are only separated by a single fastener, adhesive, chemical bond, or other attachment mechanism. The term “abutting” refers to items that are in direct physical contact with each other, although the items may not be attached together. The term “grip” refers to items that are in direct physical contact with each other, wherein one item holds the other firmly. The terms “integrally formed” refer to a body that is manufactured integrally, i.e., as a single piece, without requiring the assembly of multiple pieces. Multiple parts may be integrally formed with each other if they are formed from a single workpiece. Items that are “coupled to” each other may be formed as a single piece with each other.

Referring to FIG. 1, a side elevation view shows an airbag module 10 in a compacted configuration according to one embodiment of the invention. The airbag module 10 is designed to provide passenger 22 impact protection in an inflated state. However, those of skill in the art will recognize that the present invention is equally applicable to other types of airbags, such as knee bolsters, overhead airbags, inflatable curtains, side airbags, inflatable structural stiffeners, and the like.

As illustrated, the vehicle 12 has a seat 20 in which occupant 22 is seated. The occupant 22 has a head 24, a torso 26, and a lap 28. A seat belt 30 provides primary restraint for the occupant 22. The vehicle 12 also has a front door 32 beside the occupant 22, a windshield 34 forward of the occupant 22, and an instrument panel 36 disposed generally underneath the windshield 24. The airbag module 10 is stowed within the instrument panel 36 and is seated in a mounting recess 38 of the instrument panel 36. A decorative trim panel (not shown) or the like may be positioned over the mounting recess 38 to hide the airbag module 10 from the occupant 22.

The airbag module 10 has a cushion 40 contained within the airbag module 10, that inflates to protect the passenger 22. The airbag module 10 also has an inflator 42 positioned within the instrument panel 36 to provide inflation gas to the cushion 40. The inflator 42 may be of any known type, including compressed gas, pyrotechnic, and hybrid inflators. The cushion 40 has a compacted configuration, as shown in FIG. 1, and an inflated configuration, in which the cushion 40 is deployed to protect the passenger 22. As shown, the airbag module 10 has a cushion 40, which is illustrated in the compacted configuration. The cushion 40 has an inflated configuration (shown in phantom) and a compacted configuration shown in FIG. 1. The cushion 40 is stowed within the instrument panel 36 in the compacted configuration prior to deployment.

The airbag module 10 includes a preformed flexibly resilient housing 46 disposed within the instrument panel 36 to retain cushion 40 in the compacted configuration. The cushion 40 is attached to the preformed flexibly resilient housing 46 in such a manner that inflation gas from the inflator 42 is directed to reach the cushion 40. The cushion 40 may optionally have a vent (not shown) formed therein to release inflation gas into the passenger compartment.

In this application, a “preformed flexibly resilient housing” is a shell that is sufficiently stiff to retain a persistent preformed shape, yet still flexible when subjected to stress. A preformed shape is a shape to which a component is formed prior to assembly. Accordingly, a housing made out of thin thermoplastic (such as a thermoplastic elastomer ether ester (TEEE) or any other suitable co-polyester) and the like may be a “preformed flexibly resilient housing” provided that it maintains its formed shape while remaining flexible. In contrast, a housing formed from sheet metal, thicker plastic shapes, and the like, while maintaining a persistent preformed shape, are typically too rigid to be considered flexible. Materials such as fabric lack sufficient stiffness to maintain a preformed shape, and are therefore are not properly considered a preformed flexibly resilient housing.

One of ordinary skill in the art would recognize that there are a number of methods for forming a preformed flexibly resilient housing in accordance with the described invention. A preferred method of forming the preformed flexibly resilient housing is blow molding the housing from a material such as a thermoplastic. Alternatively, the preformed flexibly resilient housing may be formed by way of vacuum forming a thermoplastic material. In some embodiments, the preformed flexibly resilient housing may be formed by multiple layers of material. For example, the preformed flexibly resilient housing may be formed of layers of varying thermoplastics or a fabric impregnated with a thermoplastic resin. One of skill in the art would recognize that a number of potential combinations of layers are possible and the ultimate design decision is made based on the strength required in deployment of the cushion.

Further it should be understood that, where cost considerations permit, the sole purpose for the preformed flexibly resilient housing 46 may be to retain the shape of the compacted cushion. In this instance, the preformed flexibly resilient housing 46 may be disposed within a rigid housing (not shown, but known to those of skill in the art).

An electronic control unit 48, or ECU 48, is disposed within the vehicle 12. The ECU 48 need not be located as shown in FIG. 1, but may be disposed at a variety of locations within the vehicle 12. The ECU 48 may be coupled to the inflator 42 via a set of wires 50 and 52. The accelerometer 54 transmits a signal via wires 56 to the ECU 48 to indicate that a collision is occurring or is about to occur. The ECU 48 then transmits an activation signal to the inflator 42 to release inflation gas to inflate the cushion 40.

The inflator 42 may be an “adaptive” inflator designed to provide a variable quantity of inflation gas based on the severity of the impact and/or detected passenger loading. The inflator 42 may thus have two initiators (not shown) that can independently activate. For example, each initiator may provide a different quantity of inflation gas and be activated alone or together to vary the inflation gas output. The ECU 48 may be configured to determine the severity of the collision or impending collision, and thereby determine which of the initiators receive and activation signal from the ECU 48.

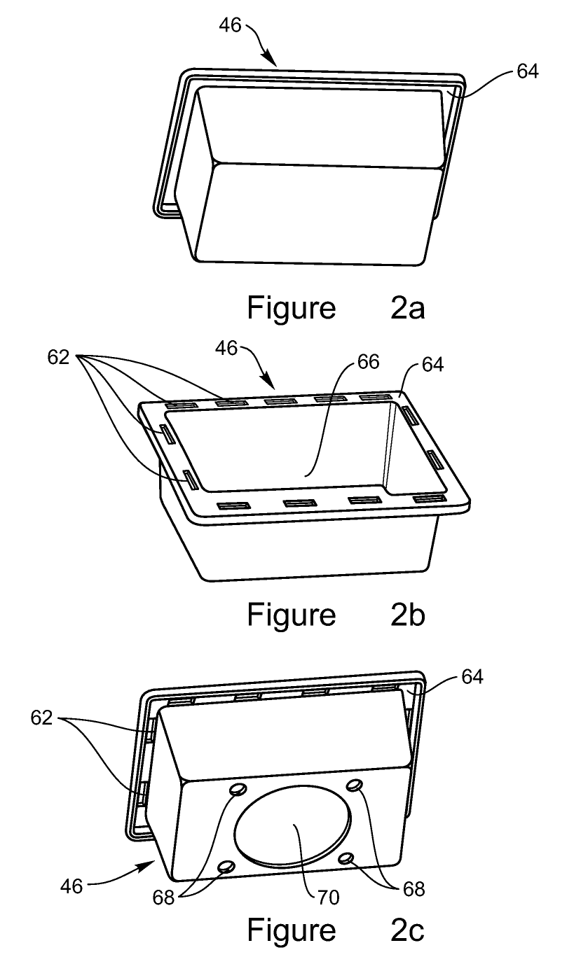

Referring to FIGS. 2a-2c, three views of a preformed flexibly resilient housing 46 are illustrated. FIG. 2a illustrates a suitable preformed flexibly resilient housing 46 having no additional features, FIG. 2b illustrates a preformed flexibly resilient housing 46 having features for secure attachment to the vehicle structure, and FIG. 2c illustrates a preformed flexibly resilient housing 46 having additional features for secure attachment to an inflation source 42. As illustrated in the figures, the preformed flexibly resilient housing 46 may be formed of a single component that has been manufactured to a predetermined shape. For example, the preformed flexibly resilient housing 46 may be vacuum formed, blow molded, or formed by any other manufacturing process resulting in the predetermined shape. The preformed flexibly resilient housing 46 may be formed to a shape having a chamber 66 for receiving an inflatable cushion 40 (not shown) in a compacted configuration, as shown by chamber 66 in FIG. 2b.

The preformed flexibly resilient housing 46 may have features adapted to secure the preformed flexibly resilient housing 46 to a vehicle structure. For example, the preformed flexibly resilient housing 46 of FIGS. 2b-2c has a series of slots 62 formed about rim 64 of the preformed flexibly resilient housing 46. While the use of slots 62 are illustrated in the respective figures, one of skill in the art would recognize that other features are possible such as tabs, holes, protrusions, or any other feature useful for securing the preformed flexibly resilient housing 46 to a vehicle structure. The slots 62 of FIGS. 2b-2c may be capable of receiving protrusions secured to the vehicle structure thereby securing the preformed flexibly resilient housing 46 to the vehicle 12. For example, instrument panel 36 may be manufactured with protrusions for securing the preformed flexibly resilient housing 46 to the instrument panel 36.

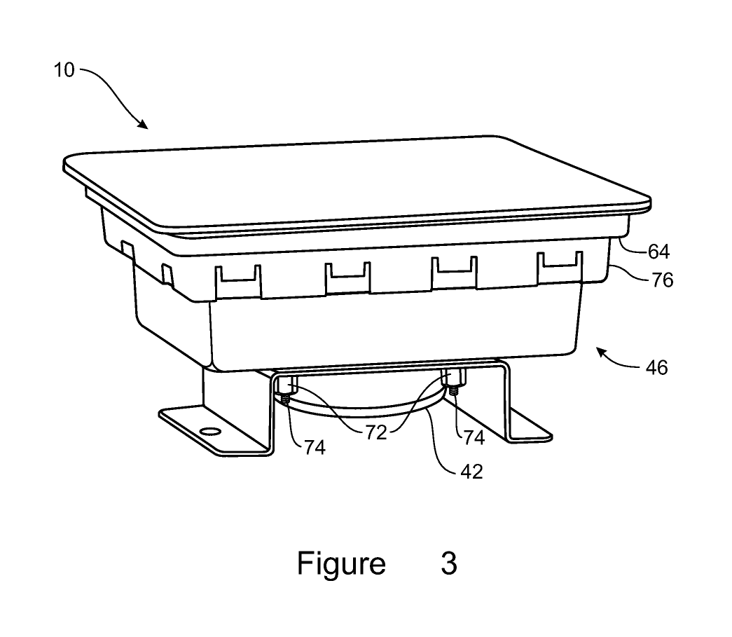

Other added features, as illustrated in FIG. 2c, may secure the preformed flexibly resilient housing 46 to an inflation gas source 42 (not shown). In FIG. 2c, the lower portion of the preformed flexibly resilient housing 46 has a series of holes 68 added around a single large hole 70 for insertion of an inflation gas source 42. The holes 68 allow the preformed flexibly resilient housing 46 to be securely attached to an inflation gas source 42 as shown in FIG. 3.

The inflation gas source 42 of FIG. 3 is attached to the preformed flexibly resilient housing 46 by a combination of nuts 72 and bolts 74. Other methods of attachment between the preformed flexibly resilient housing 46 and the inflation gas source 42 as known in the art are possible such as rivets, adhesives, and stitching.

FIG. 3 illustrates an airbag module 10 for disposition in vehicle 12. The airbag module 10 includes inflatable cushion 40 stowed in the compacted configuration. Preformed flexibly resilient housing 46 houses the compacted inflatable cushion 40 and retains the cushion 40 in its compacted shape. A collar 76 formed of rigid material receives the preformed flexibly resilient housing 46. The preformed flexibly resilient housing 46 extends through the collar 76 and is secured to the collar 76 by an interface of features between the collar 76 and the preformed flexibly resilient housing 46. The collar 76 is secured attachably to the vehicle structure, thereby securing the preformed flexibly resilient housing 46.

The rigid collar 76 may be made of any material sufficiently rigid to secure the preformed flexibly resilient housing 46. For example, the rigid collar 76 may be formed of a rigid molded material, a stamped metal material, or any other material sufficiently rigid to secure the preformed flexibly resilient housing 46. The rigid collar 76 may be in the form of a ring that surrounds the rim of the preformed flexibly resilient housing 46. The rigid collar 76 may have features to secure the rigid collar 76 to the preformed flexibly resilient housing 46 and the vehicle structure.

The preformed flexibly resilient housing 46 may be formed to envelope the compacted configuration of a particular cushion 40. For example, if cushion 40 is designed to have a particular shape when compacted, the preformed flexibly resilient housing 46 can be formed to have a chamber 66 shaped to house the compacted cushion 40 with little appreciable empty space.

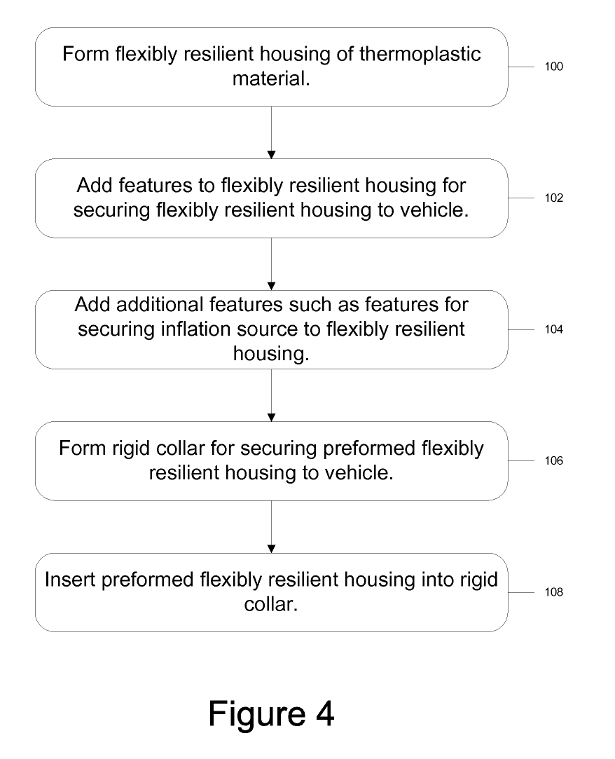

Preformed flexibly resilient housing 46 may be formed according to a variety of methods. In one particular embodiment disclosed in the flowchart of FIG. 4, a series of acts describes the method for forming the preformed flexibly resilient housing 46 (also referred to as the “flexible shell”). In act 100, a thermoplastic material is first formed to a desired shape using manufacturing techniques known in the art such as blow molding or vacuum forming. Typically, the preformed flexibly resilient housing 46 is formed to a shape to envelope a compacted configuration of an inflatable cushion 40, although the preformed flexibly resilient housing 46 may be formed to other shapes as well.

After the preformed flexibly resilient housing 46 is formed, additional features are then added to the preformed flexibly resilient housing 46 in act 102. The features can be added using commonly known techniques such as machining, punching, drilling, or any other fabrication techniques known in the art, including as part of the blow molding or vacuum forming techniques used to form the preformed flexibly resilient housing 46. The added features secure attachment of the preformed flexibly resilient housing 46 to the vehicle 12 either directly or through an intermediary component such as collar 76. As an example, the preformed flexibly resilient housing 46 may have slots 62 machined that interface with a tab secured to the vehicle 12 that extends through slots 62 to secure the preformed flexibly resilient housing 46, or the preformed flexibly resilient housing 46 may have tabs formed that extend through a matching feature of the vehicle 12. Other methods of utilizing features to secure the preformed flexibly resilient housing 46 are possible and embodiments of the invention are in no way limited to these described features.

In act 104, other features may be added to the preformed flexibly resilient housing 46. For example, additional features may be added to the preformed flexibly resilient housing 46 for secure attachment of an inflation source 42. The inflation source may in turn, be securely attached to the compacted inflatable cushion 40 housed within the preformed flexibly resilient housing 46. Alternatively, the compacted inflatable cushion 40 may be secured to the rim 64 by means of preformed flexibly resilient housing 46 features alone or in combination with features of collar 76.

In act 106, a separate rigid collar 76 may be formed to secure the preformed flexibly resilient housing 46 to the vehicle 12. The collar may have features designed to interface with the features of the preformed flexibly resilient housing 46 for securing the preformed flexibly resilient housing 46 to the rigid collar 76. Additionally, the rigid collar 76 may have features designed to interface with the vehicle 12 to secure the rigid collar 76 to the vehicle 12.

The airbag module 10 can then be assembled by inserting the preformed flexibly resilient housing 46 into the rigid collar 76, in act 108. The preformed flexibly resilient housing 46 may be held in place by a interference fit of the features of the preformed flexibly resilient housing 46 combined with the features of the rigid collar 76, or some other retaining mechanism known to those in the art. In some embodiments the rigid collar 76 may first be secured to the vehicle, such that at the time the preformed flexibly resilient housing 46 is inserted into the rigid collar 76, the preformed flexibly resilient housing 46 is secured to the vehicle 12. In other embodiments, the preformed flexibly resilient housing 46 may be attached to the rigid collar 76 prior to the rigid collar 76 being secured to the vehicle. In such embodiments the preformed flexibly resilient housing 46 is not secured to the vehicle until the rigid collar 76 is secured by an attachment mechanism.

The invention illustratively disclosed herein may be practiced suitably in the absence of any element, part, step, component, or ingredient that is not specifically disclosed herein.

While in the foregoing detailed description of this invention, the invention has been described in certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

1. An airbag module for disposition in a vehicle with a passenger chamber comprising:
a cushion inflatable from a compacted configuration, the cushion being disposed in the compacted configuration until inflation;
a preformed flexibly resilient housing formed of a flexible material into a predetermined shape for receiving the cushion in its compacted configuration; and
a collar formed of a rigid material for receiving the preformed flexibly resilient housing, the preformed flexibly resilient housing extending through the collar for disposition such that the cushion is expelled from the preformed flexibly resilient housing and passes through the collar before deploying into the passenger chamber, the collar being attached to the preformed flexibly resilient housing and attachable to the vehicle.

2. The airbag module of claim 1 wherein the preformed flexibly resilient housing comprises a blow molded thermoplastic.

3. The airbag module of claim 1 wherein the preformed flexibly resilient housing comprises a vacuum formed thermoplastic.

4. The airbag module of claim 1 wherein the preformed flexibly resilient housing is formed to envelope the compacted configuration of the cushion.

5. The airbag module of claim 1 wherein the preformed flexibly resilient housing is comprises at least two layers of thermoplastic material.

6. The airbag module of claim 1 wherein the preformed flexibly resilient housing attaches to the collar and is secured within the collar by a physical attachment between the preformed flexibly resilient housing and the collar.

7. The airbag module of claim 1 further comprising an inflation gas source being attached to the preformed flexibly resilient housing.

8. A flexible housing for retaining an inflatable cushion in a compacted configuration until inflation, the flexible housing being connectable to a vehicle structure and comprising;
a preformed flexibly resilient housing comprising at least one layer of a thermoplastic material, the preformed flexibly resilient housing being formed into a predetermined shape having a chamber for receiving the inflatable cushion in its compacted configuration until the cushion is expelled from the preformed flexibly resilient housing during deployment, the preformed flexibly resilient housing also having features adapted to secure the preformed flexibly resilient housing to the vehicle structure prior to and during deployment.

9. The flexible housing of claim 8 wherein the preformed flexibly resilient housing attaches to a vehicle instrument panel and is secured by a physical attachment between the preformed flexibly resilient housing and the instrument panel.

10. The flexible housing of claim 8 further comprising a rigid collar adapted to secure to the vehicle structure, the rigid collar for receiving the preformed flexibly resilient housing in secure attachment, wherein inflation of the inflatable cushion housed within the preformed flexibly resilient housing expels the cushion for deployment.

11. The flexible housing of claim 8 wherein at least one of the layers of the thermoplastic material comprises a polyethylene material.

12. The flexible housing of claim 8 wherein the preformed flexibly resilient housing retains the shape of the inflatable cushion in its compacted configuration and the preformed flexibly resilient housing is disposed within a rigid housing.

13. A method for forming a flexibly resilient housing for an airbag module, the method comprising:
forming a flexible shell of thermoplastic material into a persistent predetermined shape, the flexible shell being formed to envelope a compacted configuration of an inflatable airbag prior to airbag deployment and to flexibly absorb the stress of deployment;
adding features to the formed flexible shell, the features for securing the flexible shell to a vehicle prior to and during deployment of the airbag.

14. The method of claim 13 wherein at least one of the features enables secure attachment to an inflation gas source.

15. The method of claim 13 wherein the flexible shell is formed by blow molding the theremoplastic film material.

16. The method of claim 13 wherein the flexible shell is formed by vacuum forming the thermoplastic material.

17. The method of claim 13 wherein the thermoplastic material comprises multiple layers of material.

18. The method of claim 13, further comprising:
forming a rigid collar for attachment to a vehicle structure, the rigid collar formed with features to interface with the added features of the flexible shell;
inserting the flexible shell into the rigid collar such that the features of the flexible shell are secured to the features of the rigid collar.

19. The airbag module of claim 1 wherein the preformed flexibly resilient housing comprises a fabric impregnated with thermoplastic resin.
